(19) United States
(12) Patent Application Publication
(10) Pub. No.: US 2008/0260305 A1
(43) Pub. Date: Oct. 23, 2008

(54) Easy-open/reclosable bag and package

(76) Inventors: Gautam P. Shah, Simpsonville, SC (US); Frank M. Hofmeister, Simpsonville, SC (US)

Correspondence Address: Mark B. Quatt;Sealed Air Corporation, P.O. Box 464, Duncan, SC, 29334, US

(21) Appl. No.: 11/788,544

(22) Filed: Apr. 20, 2007

(51) Int. Cl. B65D 30/00; B31B 1/26; B65D 79/00

(52) U.S. Cl. 383/211; 206/525; 493/260

(57) ABSTRACT

An easy-open/reclosable bag includes a first wall having an outer and inner surface; a second wall having an outer and inner surface; a bottom portion connecting the first and second walls; a first and second side seal; and a bag mouth; the first wall including a first folded edge portion including a first and second segment, a fold, and a PSA between the first and second segments; the outer surface of the first wall including an easy-open sealant; the outer surface of the second wall including an easy-open or regular sealant; and the inner surface of the first and second walls each including a regular sealant. A method of making an easy-open/reclosable bag, and a package, are also disclosed.

### FIELD OF THE INVENTION

The present invention relates to easy-open/reclosable packaging.

### BACKGROUND OF THE INVENTION

Various products are packaged in easy-open and/or reclosable packaging.

One of the easy-open/reclosable package formats requires a sealant layer to be fractured and removed to expose the adhesive layer underneath the sealant layer when the package is opened. This exposed adhesive layer is then used to reseal the package by applying pressure. This format is disclosed in U.S. Pat. No. 5,089,320 (Straus et al.).

Another format relies on adhesive tape applied over the top of an overwrap film that was scored. Pulling the tape tears open the film along the scored line creating an opening from which the contents of the package can be accessed. The package is resealed by pressing the tape down on the top of the package. This format is disclosed in U.S. Pat. No. 6,918,532 B2 (Sierra-Gomez et al.).

Other reclosable packages employ various types of zipper mechanisms to reclose the package.

Co-extruding a resealable adhesive limits the selection of the adhesive that can be used. Also, it requires another layer of film over the adhesive layer to prevent the film from sticking during the packaging operation.

Use of tacky sealant surfaces can cause a problem of sticking to metal and other surfaces they come into contact with during the packaging operation.

Applying a zipper to a package is relatively complex and expensive.

The present invention makes use of an adhesive that is not exposed until after the package is opened.

### SUMMARY OF THE INVENTION

In a first aspect, an easy-open/reclosable bag comprises a first wall having an outer surface and an inner surface; a second wall having an outer surface and an inner surface; a bottom portion connecting the first and second walls; a first side seal; a second side seal; and a bag mouth; wherein the first wall comprises, at one end thereof distal from the bottom portion, a first folded edge portion comprising a first segment, a fold, a second segment, and a pressure sensitive adhesive disposed between and in contact with the first and second segment of the first folded edge portion; wherein the outer surface of the first wall comprises an easy-open sealant; wherein the outer surface of the second wall comprises an easy-open sealant or a regular sealant; and wherein the inner surface of the first wall, and the inner surface of the second wall, each comprises a regular sealant.

In a second aspect, a method of making an easy-open/reclosable bag comprises providing a film comprising a first surface comprising a regular sealant, a second surface comprising an easy-open sealant, a first side edge, and a second side edge; coating a first selected film segment of the first surface adjacent the first side edge with a pressure sensitive adhesive; coating a second selected film segment of the first surface adjacent the second side edge with a pressure sensitive adhesive; folding the first side edge over the coated first selected film segment of the first surface to form a first folded edge portion; folding the second side edge over the coated second selected film segment of the first surface to form a second folded edge portion; folding the film on itself along a longitudinal fold line; transversely cutting the longitudinally folded film at selected intervals to form a plurality of discrete bag preforms each having a first side preform edge and a second side preform edge; and sealing each of the first side preform edges and the second side preform edges to form a plurality of easy-open/reclosable bags each comprising a bottom portion, a first side seal, a second side seal, and a bag mouth.

In a third aspect, an easy-open/reclosable package comprises a tray comprising a tray body, a tray flange, and a tray liner, the tray liner having an outer surface comprising a regular sealant; a lid comprising an outer surface comprising an easy-open sealant, an inner surface comprising a regular sealant, and at one end of the lid, a folded edge portion comprising a first segment, a fold, a second segment, and a pressure sensitive adhesive disposed between and in contact with the first and second segment of the folded edge portion; and a product in the package; wherein the lid is sealed to at least a portion of the outer surface of the tray liner.

### BRIEF DESCRIPTION OF THE DRAWINGS

In the drawings presented by way of illustration of the invention:

FIG. 1 is a schematic view of a process and film for making a bag or package in accordance with one embodiment of the present invention.

FIG. 2 is a cross sectional view of a film useful for making a bag or package in accordance with one embodiment of the present invention.

FIG. 3 is a cross sectional view of a film useful for making a bag or package in accordance with another embodiment of the present invention.

FIG. 4A is a schematic plan view of a film having a PSA strip adjacent each of the two side edges of the film, in accordance with one embodiment of the present invention.

FIG. 4B is a schematic plan view of a film having a PSA strip adjacent each of the two side edges of the film, in accordance with another embodiment of the present invention.

FIG. 4C is a schematic plan view of a film having a PSA strip adjacent each of the two side edges of the film, in accordance with yet another embodiment of the present invention.

FIG. 5 is a cross sectional view of a film useful for making a bag or package in accordance with a portion of FIG. 4A, with a PSA strip installed adjacent a side edge of the package.

FIG. 6 is a cross sectional view of a portion of the film of FIG. 4A, with a portion of the film partially folded over the PSA strip.

FIG. 7 is a cross sectional view of the film of a portion of FIGS. 4A and 5, with a portion of the film completely folded over the PSA strip.

FIG. 8 is a cross sectional view of a film useful for making a package in accordance with a portion of FIG. 4A, with a PSA strip installed adjacent a second side edge of the package.

FIG. 9 is a cross sectional view of a portion of the film of FIG. 4A, with a portion of the film partially folded over the PSA strip.

FIG. 10 is a cross sectional view of a portion of the film of FIG. 4A, and FIG. 8, with a portion of the film completely folded over the PSA strip.

FIG. 11 is a schematic plan view of the process and film of FIG. 1, where each of the two side edges of the film have been folded in accordance with FIGS. 5 to 10, and the film has been folded over along its longitudinal centerline.

FIG. 12 is a cross sectional view of the film of FIG. 11, taken along line A-A thereof, wherein a bag mouth is formed.

FIG. 13 is a cross sectional view of the film of FIG. 11, wherein the bag mouth is sealed with a peelable heat seal.

FIG. 14 is a simplified plan view of a bag in accordance with one embodiment of the present invention.

FIG. 15 is a simplified perspective view of a bag preform in accordance with one embodiment of the present invention, before the first and second sides of the bag, and the bag mouth, have been sealed.

FIG. 16 is a cross sectional view of a package including a tray and a lid in accordance with yet another embodiment of the present invention.

FIG. 17 is an enlarged cross sectional view of a portion of the package of FIG. 16.

FIG. 18 is a cross sectional view of a laminate of two films useful for making a bag or package in accordance with another embodiment of the present invention.

FIG. 19 is a cross sectional view of a film or films, wherein a bag mouth is formed, in accordance with another embodiment of the invention.

Drawings herein are not necessarily to scale.

### DETAILED DESCRIPTION OF THE INVENTION

### Definitions

“Adjacent” herein refers to a segment or portion immediately next to, or alternatively near, a given point of reference.

“Bag” herein refers to a bag or a pouch.

“Coated” herein refers to the application of a pressure sensitive adhesive (PSA) to the film by any suitable means, including manually (using a brush or roller), or mechanically. Exemplary techniques include screen, gravure, flexographic, roll, and metering rod coating processes. The PSA will cover all or a substantial portion of the relevant segment of the film—that is, cover a sufficient portion of a relevant segment of the film to provide the desired performance. The PSA is in one embodiment transparent.

“Ethylene/alpha-olefin copolymer” (EAO) herein refers to copolymers of ethylene with one or more comonomers selected from C₃ to C₁₀ alpha-olefins such as propene, butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ and ATTANE™ resins supplied by Dow, and ESCORENE™ resins supplied by Exxon; as well as linear homogeneous ethylene/alpha olefin copolymers (HEAO) such as TAFMER™ resins supplied by Mitsui Petrochemical Corporation, EXACT™ and EXCEED™ resins supplied by Exxon, long chain branched (HEAO) AFFINITY™ resins and ELITE™ resins supplied by the Dow Chemical Company, ENGAGE™ resins supplied by Du-Pont Dow Elastomers, and SURPASS™ resins supplied by Nova Chemicals.

“Ethylene homopolymer or copolymer” herein refers to ethylene homopolymer such as low density polyethylene; ethylene/alpha olefin copolymer such as those defined herein; ethylene/vinyl acetate copolymer; ethylene/alkyl acrylate copolymer; ethylene/(meth)acrylic acid copolymer; or ionomer resin.

“Film” herein means a flexible film, laminate, sheet, web, coating, or the like.

“Olefinic” and the like herein refers to a polymer or copolymer derived at least in part from an olefin monomer.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, also referred to generally as “copolyamides” herein.

“Polymer” and the like herein means a homopolymer, but also copolymers thereof, including bispolymers, terpolymers, etc.

“Pressure sensitive adhesives” herein refers to adhesives that bond firmly with the application of light pressure. They adhere to most surfaces with very slight pressure; are available in solvent and latex or water based forms, and are often based on non-crosslinked rubber adhesives, acrylics, or polyurethanes. They form viscoelastic bonds that are aggressively and permanently tacky; adhere without the need for more than hand pressure; and require no activation by water, solvent, or heat. Some PSA materials are cured by electron beam, UV, or chemical (peroxide) means. They are available in a wide variety of chemical compositions and systems including acrylic and methacrylate adhesives, rubber-based pressure sensitive adhesives, styrene copolymers (styrene/isoprene/styrene and styrene/butadiene/styrene block copolymers), and silicones.

“Copolymer” herein refers to a polymer formed by the polymerization reaction of at least two different monomers and is inclusive of random copolymers, block copolymers, graft copolymers, etc.

“Solid state oriented” herein refers to films obtained by either coextrusion or extrusion coating of the resins of the different layers to obtain a primary thick sheet or tube (primary tape) that is quickly cooled to a solid state to stop or slow crystallization of the polymers, thereby providing a solid primary film sheet, and then reheating the solid primary film sheet to the so-called orientation temperature, and thereafter biaxially stretching the reheated film sheet at the orientation temperature using either a tubular solid-state orientation process (for example a trapped bubble method) or using a simultaneous or sequential tenter frame process, and finally rapidly cooling the stretched film to provide a heat shrinkable film. In the trapped bubble solid state orientation process the primary tape is stretched in the transverse direction (TD) by inflation with air pressure to produce a bubble, as well as in the longitudinal direction (LD) by the differential speed between the two sets of nip rolls that contain the bubble. In the tenter frame process the sheet or primary tape is stretched in the longitudinal direction by accelerating the sheet forward, while simultaneously or sequentially stretching in the transverse direction by guiding the heat softened sheet through a diverging geometry frame.

“g/cc” herein refers to grams/cubic centimeter.

“Heat shrinkable” herein refers to a property of a material which, when heated to a temperature of 185° F., will exhibit a free shrink (ASTM D 2732) of at least 4%, and in particular at least 5%, 10%, 15%, or 20% in the longitudinal direction, and/or at least 4%, and in particular at least 5%, 10%, 15%, or 20% in the transverse direction. Heat shrinkable films of this invention are solid state oriented as contrasted to hot blown films which are melt state oriented.

“Tray liner” herein refers to a discrete monolayer or multilayer film, or coating, that is coextensive with and adhered to the side of a tray that is intended to be in contact (by means of the tray liner) with a product, and to be sealed to a lidstock. Alternatively, “tray liner” herein can refer to an integral portion of a tray, coextensive with the remainder of the tray, that is intended to be in contact with a product, and to be sealed to a lidstock.

“Seal strength” herein refers to the strength of a seal as determined by an evaluation in which samples are brought together in a face to face relationship. In this evaluation, one end of the two adjoining webs is sealed together to form a one inch wide seal along the length of the two juxtaposed webs. The seal is made using a seal bar at a temperature of 325° F., at 40 psi, for 1.0 second. Seals are made using a SENCORP™ Sealer Model No. 12ASL/1, using a one inch strip cutter. Strips of each sealed sample, one inch wide and three inches long, excluding the sealed edge, are then tested on an INSTRON™ tensile tester. The samples are tested using a standard ASTM F88-05 procedure with a crosshead speed of 8-12 inches/minute and an initial jaw gap of 0.39 to 1.00 inch. In this method, each unsealed edge of the test specimen is gripped by a separate clamp. The sealed edges are then gradually pulled apart while a dynamometer registers readings of the force involved. The maximum force encountered as each specimen is stressed to failure is recorded and expressed preferably in Newtons/meter, lbf/in. (pounds force per inch) or Gmf/in. (grams force per inch).

The physical mode of failure of a sealant may include actual peeling of two adjoining faces of the sealant along the sealed interface between the two faces; or alternatively a break within a sealant layer, by e.g. rupturing of the sealant material itself. This later phenomenon is sometimes referred to as cohesive failure. In yet another mode, the sealant layer may break completely through, and peeling may then occur between the sealant layer and an adjacent layer, along a plane bounded by both the sealant and adjacent layer. This later phenomenon is sometimes referred to as delamination failure.

“Easy-open sealant” herein refers to any suitable polymer or polymer blend that comprises at least a majority of the film layer in which the easy-open sealant is disposed, wherein the easy-open sealant exhibits a seal strength (ASTM F88-05), as defined herein, that is less than the seal strength of the regular sealant as defined herein. Typical seal strengths can range from e.g. 25 grams/inch to 3 pounds/inch, e.g. from 100 grams/inch to 2 pounds/inch, such as from 200 grams/inch to 1 pound/inch. An easy-open sealant as described herein, when adhered to itself or another pre-selected surface, will typically allow the user to open the seal with relatively little effort. In some cases, the sealant may actually peel away from the surface to which it is adhered, or alternatively a rupture of the sealant (cohesive failure) or even breakage of the sealant and delamination along an adjacent layer interface may occur. All of these opening mechanisms are contemplated herein. Examples of easy-open sealants include without limitation the following:

(1) DuPont APPEEL™ resins, such as those based on EVA, modified EVA, ethylene/acrylate copolymer, or modified ethylene/acrylate copolymer.

(2) Polyethylenes such as low density polyethylene (LDPE) and/or EVA copolymers blended with polypropylene.

(3) Polyethylene (LDPE or EVA) blended with polybutene-1, or random propylene/ethylene copolymer blended with polybutene-1. VERSIFY™ propylene/ethylene copolymer resins commercially available from Dow include the following grades: VERSIFY™ 2000, VERSIFY™ 2200, VERSIFY™ 2400, VERSIFY™ 3000, VERSIFY™ 3200, VERSIFY™ 3401, VERSIFY™ 4000, and VERSIFY™ 4200.

(4) EVA or LDPE blended with polypropylene.

(5) LDPE blended with EVA and polypropylene, useful e.g. for high surface area, very low seal strength applications. Such blends provide an easy-open sealant when adhered to polyethylene sealants.

Suitable easy-open sealants (sometimes referred to as peelable sealants) for use in embodiments of the present invention are disclosed in U.S. Pat. No. 4,875,587 (Lulham et al.), U.S. Pat. No. 5,023,121 (Pockat et al.), U.S. Pat. No. 5,024,044 (Friedrich et al.), U.S. Pat. No. 6,395,321 (Schaft et al.), U.S. Pat. No. 6,476,137 (Longo), and U.S. Pat. No. 7,055,683 (Bourque et al.), and US Patent Publication No. 20030152669 (Vadhar et al.); all incorporated herein by reference in their entirety.

“Regular sealant” herein refers to any suitable polymer or polymer blend that comprises at least a majority of the film layer in which the regular sealant is disposed, wherein the regular sealant exhibits a seal strength (as measured by ASTM F 904-98), as defined herein, that is greater than the seal strength of the easy-open sealant of the same bag. Typical seal strengths for the regular sealant can range from e.g. 100 grams/inch to 30 pounds/inch, e.g. from 3 pounds/inch to 20 pounds/inch, such as from 5 pounds/inch to 10 pounds/inch. The seal strength of the regular sealant can in some embodiments be greater than the seal strength of the easy-open sealant by a difference of at least 75 grams per inch, e.g. at least 0.5, 1.0, 2.0, 3.0, 5, 10, 15, 20, or 25 pounds per inch, e.g. from 0.5 to 20 pounds, such as from 1 to 15, or 5. to 10 pounds per inch. Examples of regular sealants include without limitation the following:

(1) Ziegler-Natta catalyzed linear low density polyethylenes (LLDPE's) such as DOWLEX™ 2045.03, an ethylene-octene copolymer with an octene content of 6.5% by weight of the copolymer, having a density of 0.920 g/cc, and melt index of 1.1; DOWLEX™ 2045.04, an ethylene-octene copolymer having a density of 0.920 g/cc, and melt index of 1.0; and DOWLEX™ 2247G, an ethylene-octene copolymer having a density of 0.917 g/cc, and melt index of 2.30.

(2) Metallocene-catalyzed LLDPE's (“m-LLDPE”) such as Exxon EXCEED™ 4518PA, an ethylene-hexene copolymer having a density of 0.918 g/cc, and melt index of 4.5, and Exxon EXCEED™ 3518CB, an ethylene-hexene copolymer having a density of 0.918 g/cc, and melt index of 3.5.

(3) Polyolefin “plastomer” grade polyethylenes (“VLDPE”) with high comonomer incorporation, comonomers selected from octene or hexene and/or butene, such as Dow AFFINITY™ PL 1888G, an ethylene-octene copolymer having a density of 0.9035 g/cc, and a melt index of 1.0; Dow AFFINITY™ PL 1850G, an ethylene-octene copolymer with 12% octene by weight of the copolymer, having a density of 0.902 g/cc, and a melt index of 3.5; Dow AFFINITY™ PL 1850, an ethylene-octene copolymer with 12% octene by weight of the copolymer, having a density of 0.9020 g/cc, and a melt index of 1.0; ExxonMobil EXACT™ 4151, an ethylene-hexene copolymer having a density of 0.8950, and a melt index of 2.2; and ExxonMobil EXACT™ 3024, an ethylene-butene copolymer having a density of 0.9050 g/cc, and a melt index of 4.5.

(4) Polyolefin “elastomer” grade polyethylenes such as Dow AFFINITY™ EG 8100, an ethylene-octene copolymer having a density of 0.870 g/cc, and a melt index of 1.0; and DuPont-Dow ENGAGE™ resins.

(5) Propylene-ethylene copolymer, including “plastomer” grades.

(6) Other “enhanced” copolymer grades, such as Dow ELITE™ 5400G, an ethylene-octene copolymer having a density of 0.917 g/cc, and having a density of 1.1.

(7) LDPE, such as Huntsman PE 1042cs15™, a free radical polymerized ethylene homopolymer having a density of 0.922 g/cc, and a melt index of 2.0; and ExxonMobil ESCORENE™ LD-200.48 0.915/7.5, a free radical polymerized ethylene homopolymer.

(8) Ionomer resin, such as SURLYN™ 1650 from DuPont.

(9) ethylene/vinyl acetate copolymers (EVA).

(10) ethylene/methyl (meth)acrylate (EMA) copolymers.

(11) ethylene/butyl acrylate (EBA) copolymers.

In one embodiment, the film layer in which the regular sealant is disposed exhibits a seal strength of at least 3.5 pounds per inch, such as at least 4.0, 4.5, 5.0, and at least 6 pounds per inch, or 3.5, 4.0, 4.5, 5.0, or 6 pounds per inch. In another embodiment, the film layer in which the regular sealant is disposed exhibits a seal strength of from 3.0 to 6.0 pounds per inch, such as 3.5 to 5.5, and 4.0 to 5.0 pounds per inch.

All compositional percentages used herein are presented on a “by weight” basis, unless designated otherwise.

### EXAMPLES

Process

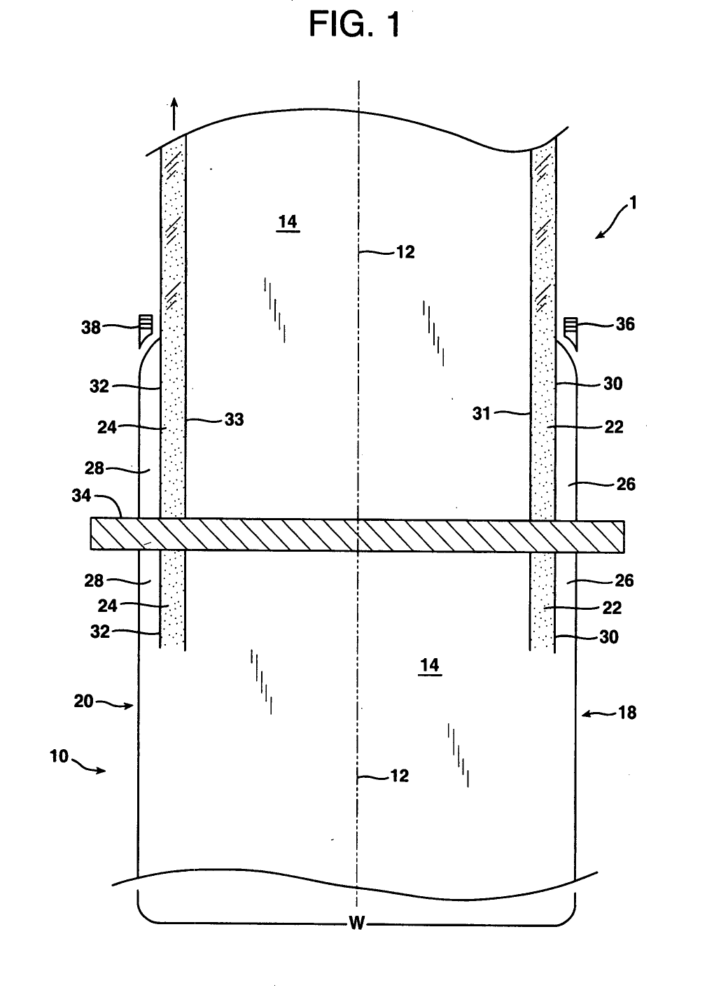

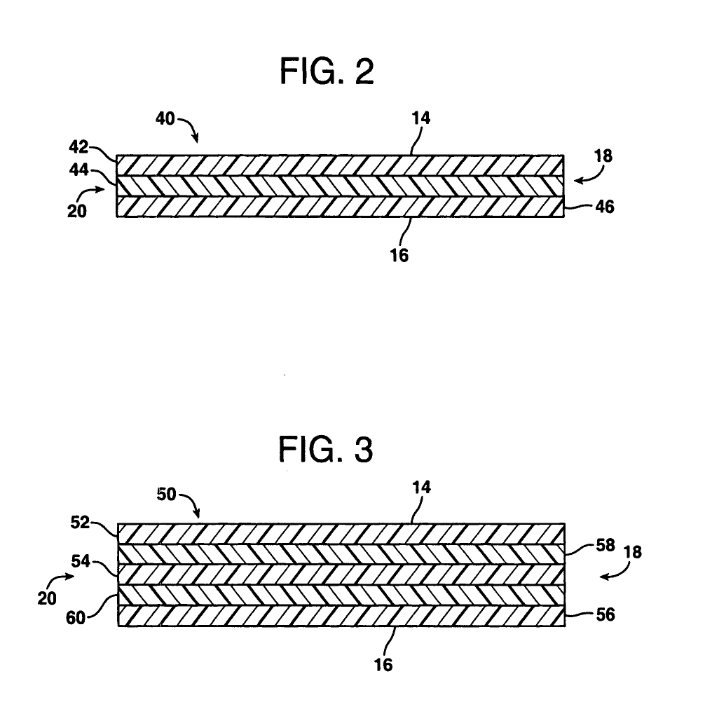

FIG. 1 is a schematic view of a process 1 for making a package in accordance with one embodiment of the present invention. Those skilled in the art will recognize that the process can be carried out on any suitable equipment, utilizing in one embodiment a horizontal flat metal static work surface or a conveyor. Film 10 is advanced, in the direction of the arrow, as a lay-flat web from a film source such as a roll of film (not shown). The film 10 has an initial width “w”, and can be characterized as having a longitudinal center line 12. The film has a first outer film surface 14 and a second outer film surface 16 (see FIGS. 2 and 3). The film has a first film side edge 18 and a second film side edge 20.

Any suitable film, of any suitable number of layers, can be used in connection with the present invention. Embodiments of film suitable for use in the present invention are discussed in more detail below.

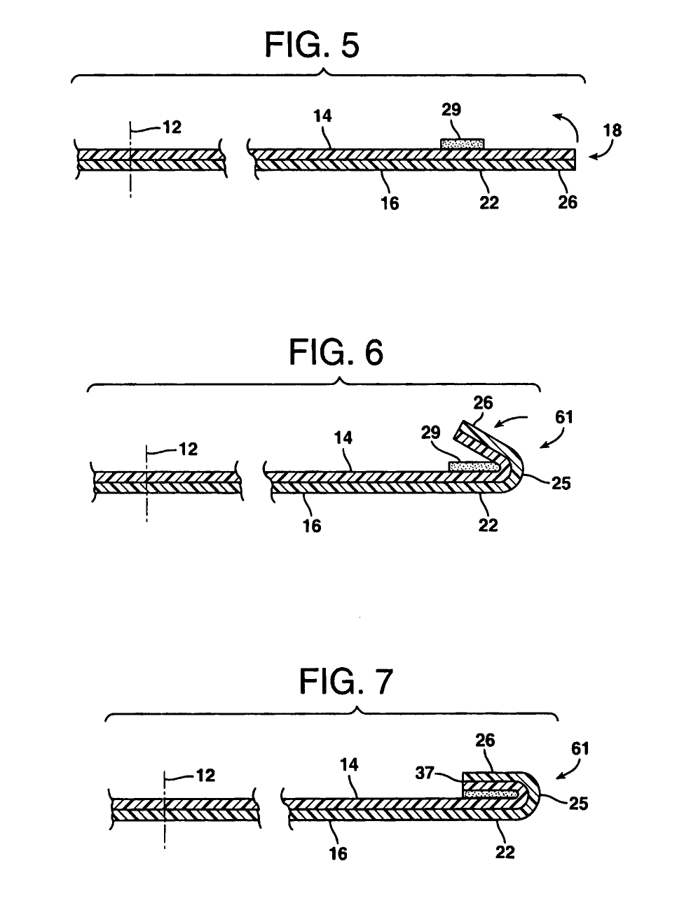

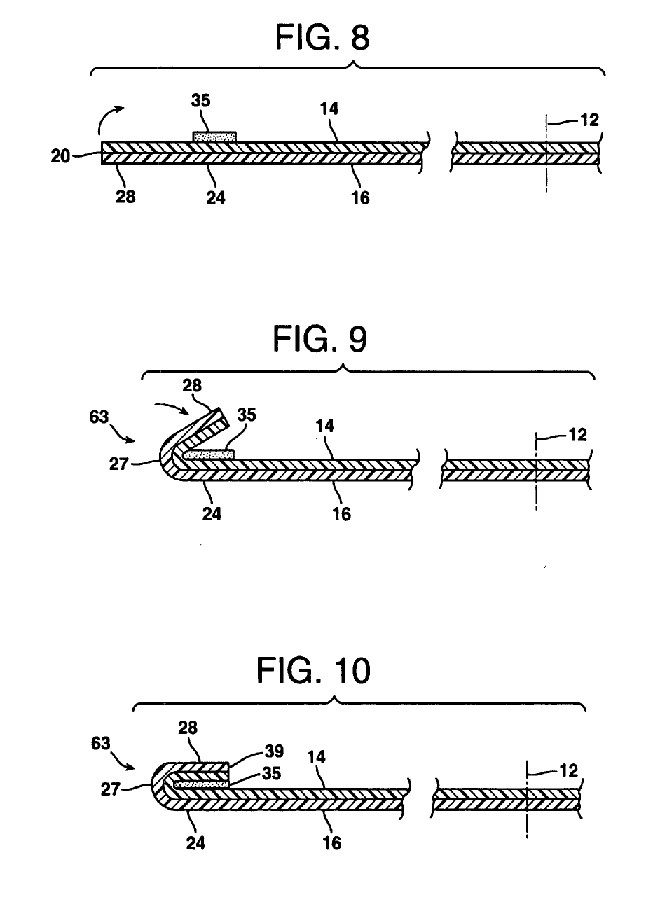

Downstream of the initial introduction of film 10 to the process 1, a pressure sensitive adhesive (PSA) is applied as a thin coat 29 (see also FIGS. 5 to 7) to film surface 14 along a first film segment 22 near and generally parallel to the first film side edge 18, and is applied as a thin coat 35 (see also FIGS. 8 to 10) to film surface 14 along a second film segment 24 near and generally parallel to the second film side edge 20.

The first and second film segments 22 and 24 effectively form two discrete bands that run along the film surface 14 adjacent respective film sides edges 18 and 20 of the film. The PSA is depicted in FIG. 1 as a stippled area of the film; in FIGS. 5 to 10 as a raised area of suitable thickness and width disposed on selected portions of first outer film surface 14.

The PSA can be applied manually or by any suitable metering or application method, and can be applied in its wet state at any suitable thickness, and in its dried state can be of any suitable thickness, and can vary in thickness from one portion of the film to another, provided that the PSA serves to function, in conjunction with the other elements of the present invention, as an easy open/reclosable system. The PSA is applied in a thickness that once cured is effective to provide the desired functionality. Useful PSA thicknesses (when dry) include from 0.1 to about 25 μm, from 0.5 to 20 μm, from 1.0 to 15 μm, from 1.5 to 10 μm, and from 1.5 to 5 μm.

In the embodiment shown in FIG. 1, the first film segment 22 and the second film segment 24 are shown as having a continuous coating or application of PSA. In another embodiment of the invention, the PSA of either or both of these segments can be discontinuous in nature, either longitudinally or laterally, or both, provided that the PSA serves to function, in conjunction with the other elements of the present invention, as an easy open/reclosable system. Thus, the PSA will cover all or a substantial portion of the respective film segment—that is, cover a sufficient portion of the respective film segment to provide the desired performance.

The PSA is in one embodiment transparent or substantially transparent when dry.

In the embodiment shown in FIG. 1, a third film segment 26 and a fourth film segment 28 are shown. The third film segment 26 is defined and bound by first film fold line 30 and first film side edge 18. The fourth film segment 28 is defined and bound by second film fold line 32 and second film side edge 20. The third film segment 26 and fourth film segment 28 are shown without PSA coated or applied thereon.

Thus, third and fourth film segments 26 and 28 effectively form two discrete bands that run along the film adjacent respective film sides edges 18 and 20 of the film, and that in one embodiment do not carry a PSA coat.

The applicants have found that applying the PSA to first film segment 22 and to second film segment 24, but not to third film segment 26 and fourth film segment 28, results in a easy open/reclosable feature that is easier to use than when all four film segments 22, 24, 26, and 28 include a PSA thereon.

Nevertheless, in an alternative embodiment, either or both of third and fourth film segments 26 and 28 can also be coated, in addition to first and second film segments 22 and 24.

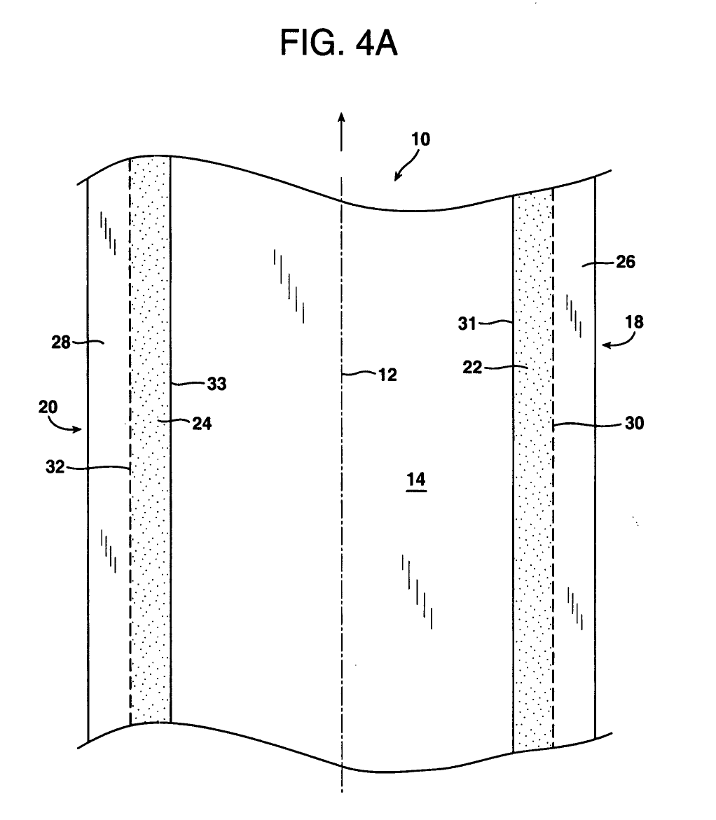

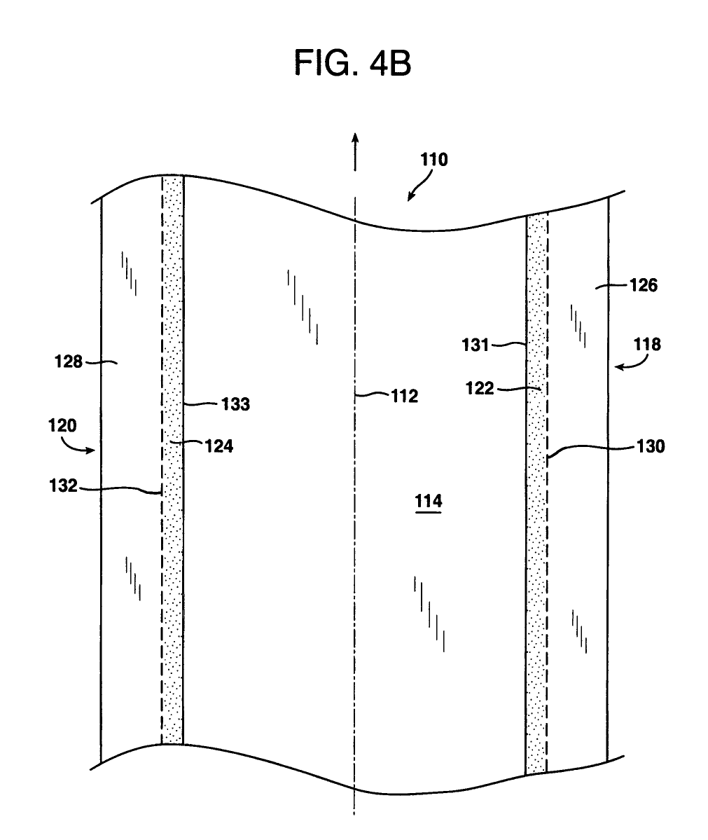

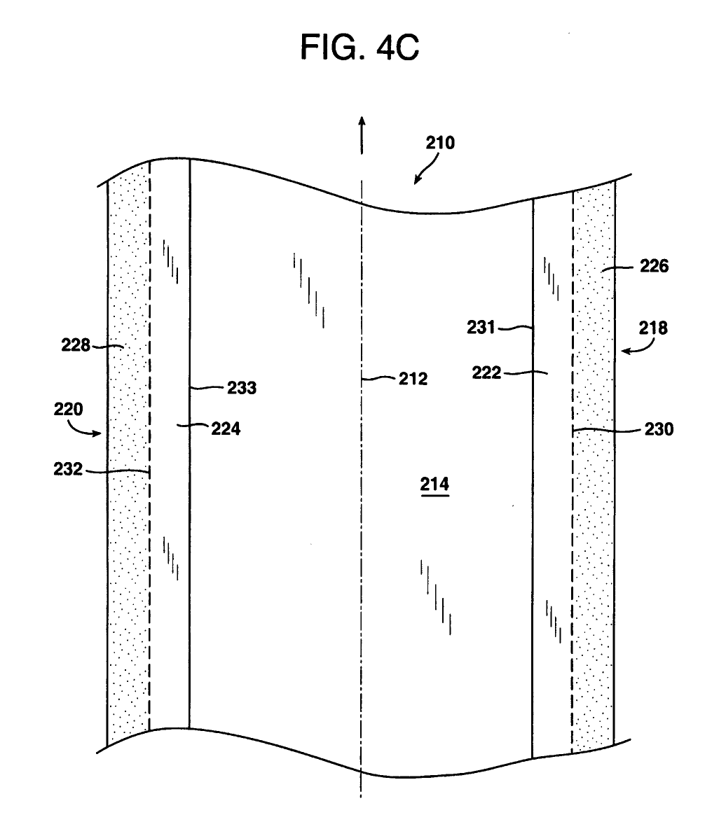

In another alternative embodiment, either or both of the third and fourth film segments 26 and 28 can be coated, instead of first and second film segments 22 and 24 respectively (see also FIG. 4C).

It will be seen herein that in one embodiment first film fold line 30 and second film fold line 32 simply define a convenient location along which to longitudinally fold respective portions of the film 10 to help create the easy-open/reclosable feature of the invention. Alternatively, first and second film fold lines 30 and 32 can include an actual scoring or printing or other physical effect to visually guide the folding of the film (especially if done manually or by an optically controlled system) or to mechanically facilitate film folding.

The first, second, third and fourth film segments 22, 24, 26 and 28 can each be of any suitable lateral width as measured transversely across the film, e.g. can each have a width of 0.75 inches. Suitable widths for each film segment are e.g. from 0.1 to 2.0 inches, such as from 0.25 to 1.5 inches, and from 0.5 to 1.0 inches.

The film fold line 30 is in one embodiment disposed an equal distance from the first film edge 18 and the edge 31 of the first film segment 22 closest to the longitudinal center line 12 of film 10 (see FIGS. 1 and 4A). This arrangement permits the third film segment 26 to be folded over the first film segment 22, along film fold line 30, in an operation described further herein, such that third film segment 26 is adhered to first film segment 22, by means of the PSA, in an easy-open/reclosable manner. The first film segment 22 and third film segment 26 will in this embodiment be substantially coextensive when folded as described herein.

The film fold line 32 is in one embodiment disposed an equal distance from the second film edge 20 and the edge 33 of the second film segment 24 closest to the longitudinal center line 12 of film 10 (see FIGS. 1 and 4A). This arrangement permits the fourth film segment 28 to be folded over the second film segment 24, along film fold line 32, in an operation described further herein, such that fourth film segment 28 is adhered to second film segment 24, by means of the PSA, in an easy-open/reclosable manner. The second film segment 24 and fourth film segment 28 will in this embodiment be substantially coextensive when folded as described herein.

In another embodiment, film fold line 30 can be located so that it is not equidistant from the first film edge 18 and the edge 31 of the first film segment 22. In one embodiment, the first film segment 22 is narrower in width than the third film segment 26. In FIG. 4B, the features of reference numerals 110, 112, 114, 118, 120, 122, 124, 126, 128, 130, 131, 132 and 133 correspond to like features of reference numerals 10 , 12, 14, 18, 20, 22, 24, 26, 28, 30, 31, 32 and 33 of FIGS. 1 and 4A. It will be noted that first film segment 122 of FIG. 4B is narrower in width than third film segment 126. In this embodiment, a relatively narrow band of PSA will be covered, when the film is folded, such that some of the film of the third film segment 126 will extend laterally beyond the edge of the PSA.

It should be noted that PSA acts as a contaminant, with respect to sealing, such that it will prevent otherwise sealable materials from making a strong seal. Therefore, in this embodiment, care should be taken to seal the first and second side edges of the final bag only up to the terminus of the third film segment 126. Otherwise, the portion of third film segment 126 not covered with PSA, and having a surface comprising a regular sealant, will seal to surface 14 comprising a regular sealant, and form a seal that will prevent the desired exposure of the PSA by unfolding the relevant film segments.

In another embodiment, film fold line 32 can be located so that it is not equidistant from the second film edge 20 and the edge 33 of the second film segment 24. In one embodiment, the second film segment 24 is narrower in width than the fourth film segment 28. Referring again to FIG. 4B, it will be noted that second film segment 124 of FIG. 4B is narrower in width than fourth film segment 128. In this embodiment, a relatively narrow band of PSA will be covered, when the film is folded, such that some of the film of the fourth film segment 128 will extend laterally beyond the edge of the PSA. As mentioned earlier, PSA acts as a contaminant, with respect to sealing, such that it will prevent otherwise sealable materials from making a strong seal. Therefore, in this embodiment, care should be taken to seal the first and second side edges of the final bag only up to the terminus of the fourth film segment 128. Otherwise, the portion of fourth film segment 128 not covered with PSA, and having a surface comprising a regular sealant, will seal to surface 14 comprising a regular sealant, and form a seal that prevents the desired exposure of the PSA by unfolding the relevant film segments.

In another embodiment, in FIG. 4C, the features of reference numerals 210, 212, 214, 218, 220, 222, 224, 226, 228, 230, 231, 232 and 233 correspond to like features of reference numerals 10, 12, 14, 18, 20, 22, 24, 26, 28, 30, 31, 32 and 33 of FIGS. 1 and 4A, and reference numerals 110, 112, 114, 118, 120, 122, 124, 126, 128, 130, 131, 132 and 133 of FIGS. 1 and 4B. It will be noted that first film segment 222 of FIG. 4C, and the second film segment 224, do not carry a PSA coat, while the third film segment 226 and fourth film segment 228 are coated with a PSA.

In one embodiment, the first and second film segments are of the same or substantially the same width.

In one embodiment, the third and fourth film segments are of the same or substantially the same width.

To shorten the time that the applied PSA requires to dry sufficiently to be useable in the inventive process, a conventional dryer 34 (see FIG. 1) of any suitable type, such as a hot air or radiant dryer, can be employed. As shown, dryer 34 is suspended above the lay flat film 10 downstream of the point at which the PSA has been applied to the film. Alternative devices or arrangements can be used, such as a heated oven through which the film passes, hot air nozzles directed at the specific portions of the film that are coated with the PSA, etc.

In the embodiment shown in FIG. 1, after the PSA has been applied to the film and after any drying step, each of the film edges 18 and 20 are folded over as shown. This operation can be done manually, or by any suitable device including any suitable mechanical device, such as a folding device, such as a static folding device, such as folding plows or shoes 36 and 38. These devices can be used by taking advantage of relative movement of the film with respect to the position of the folding devices to induce the film edges to fold over onto itself to trap the PSA between respective film segments.

Referring to FIGS. 5 to 7, third film segment 26 is folded over first film segment 22 so that the two segments are adhered together by PSA coat 29. The folding action results in an edge fold 25 formed between the third film segment 26 and first film segment 22. The first film segment 22, third film segment 26, and edge fold 25 together constitute a first folded edge portion 61. As shown in the folded condition, the terminus 37 of third segment 26 is coextensive with the edge of PSA coat 29. Alternatively, and in accordance with the embodiment of FIG. 4B, the terminus 37 of third segment 26 can extend somewhat beyond the edge of PSA coat 29. Such an alternative may be useful where it is desired to have, in the finished bag, a bag mouth where the terminus of the two folded edge portions of the bag have selected areas without a PSA coating. This embodiment should be practiced, however, with the care discussed hereinabove with respect to the embodiments of FIG. 4B.

Referring to FIGS. 8 to 10, fourth film segment 28 is folded over second film segment 24 so that the two segments are in contact with and adhered together by PSA coat 35. The folding action results in an edge fold 27 formed between the fourth film segment 28 and the second film segment 24. The second film segment 24, fourth film segment 28, and edge fold 27 together constitute a second folded edge portion 63. As shown in the folded condition, the terminus 39 of fourth film segment 28 is coextensive with the edge of PSA coat 35. Alternatively, and in accordance with the embodiment of FIG. 4B, the terminus 39 of fourth film segment 28 can extend somewhat beyond the edge of PSA coat 35. Such an alternative may be useful where it is desired to have, in the finished bag, a bag mouth where the terminus of the two folded edge portions of the bag have selected areas without a PSA coating. This embodiment should be practiced, however, with the care discussed hereinabove with respect to the embodiments of FIG. 4B.

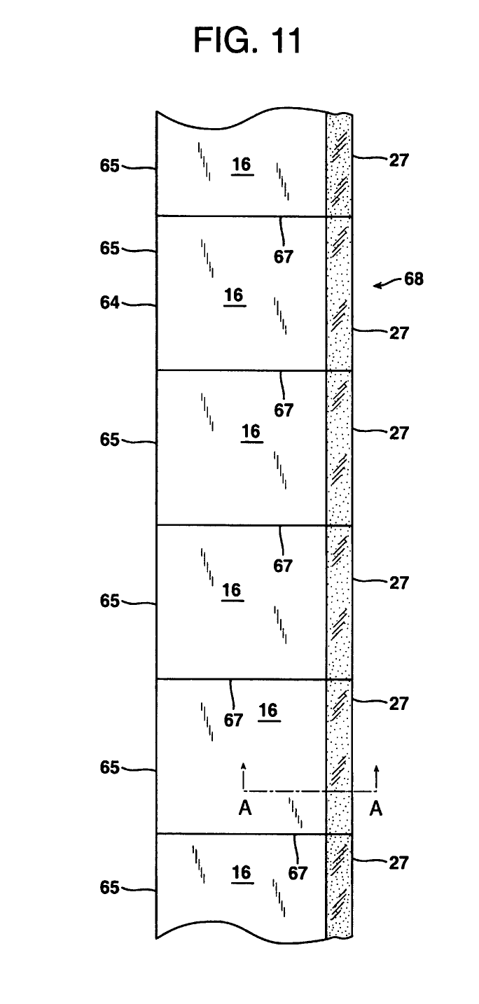

After first folded edge portion 61 and second folded edge portion 63 are formed, the film 10 is folded along its longitudinal centerline 12 such that the two folded edge portions 61 and 63 are brought together (see FIG. 11). This longitudinal folding operation can be done manually, or by any suitable device including any suitable mechanical device, such as a folding device such as a folding plow or shoe (not shown). This device can be used by taking advantage of relative movement of the film with respect to the position of the folding device to induce the film to fold over onto itself along its longitudinal centerline 12. FIG. 11 is a schematic view of the process of FIG. 1, where each of the two side edges of the film have been folded in accordance with FIGS. 5 to 10, and the entire film has been folded over along its centerline 12. The longitudinal fold 64 thus formed, will, after individual bags are made in accordance with the invention, result in a bottom fold 65 for each bag so made. Thus, although the longitudinally centerfolded film is shown in FIG. 11 with a single longitudinal fold 64, this fold, after subsequent production of a plurality of bag preforms and then bags, will ultimately convert into a plurality of bottom folds 65, shown here for convenience, each bottom fold 64 forming part of a respective finished bag.

Although the film in one embodiment is folded along its longitudinal center line 12, any desirable longitudinal fold line can be chosen as long as the resulting bags will function for their intended purpose. Bags made in accordance with the invention, in such embodiments, would have walls of somewhat unequal length.

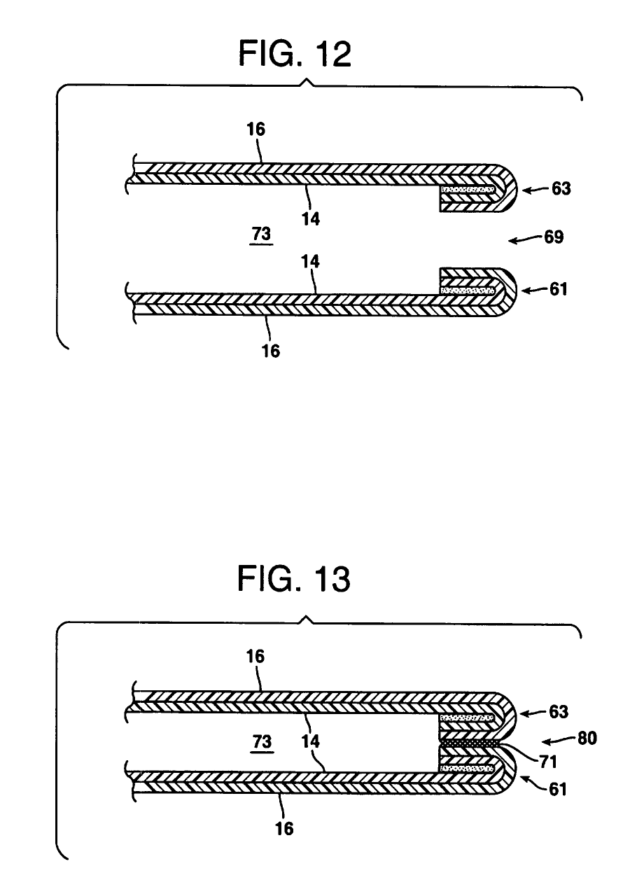

FIG. 12 is a cross sectional view of the film of FIG. 11, wherein the opening 68 formed at one side of the folded film, will, after individual bags are made in accordance with the invention, result in a bag mouth 69 for each bag so made.

After the longitudinal folding step, several alternatives are available for making individual bags.

In one embodiment, one side of folded film 10, the side shown by opening 68 (see FIG. 11) can be sealed by any suitable sealing device such as a continuous sealing system, e.g. of the type commonly used to create longitudinal seals in vertical form/fill/seal or horizontal form/fill/seal packaging equipment. Thus, as the film 10 is continuously longitudinally folded, it is also filled with product in an in-line process and continuously sealed to create an easy open/reclosable seal as shown in FIG. 13.

A common heat seal method uses a heat seal jaw at an elevated temperature to both apply pressure and heat the film being heat sealed above the heat seal initiation temperature. The heat seal jaw will typically contact the outside of the film. The PSA is chosen to be capable of withstanding the elevated temperature associated with the heat seal process.

The seals described herein will typically be heat seals, using heat seal equipment well known in the art; or seals produced by radio frequency sealing, or by ultrasonic sealing, using equipment and techniques well known in the art. The folded and sealed film can then be transversely cut and sealed at predefined intervals to create a series of individual bags. FIG. 11 shows a series of lines 67 that represent cuts that can be made in the film to produce individual bag preforms In which the cuts form the side edges of the individual bag preforms and the location at which side seals of bags can be made.

In another embodiment, the cuts and transverse seals can first be made to produce a plurality of bags each having an open bag mouth 69, and thereafter each bag can be filled with the desired product and then sealed in the area of the bag mouth to create a closure seal 71 (see FIG. 13).

In either embodiment, the cuts and traverse seals can be performed either sequentially or simultaneously.

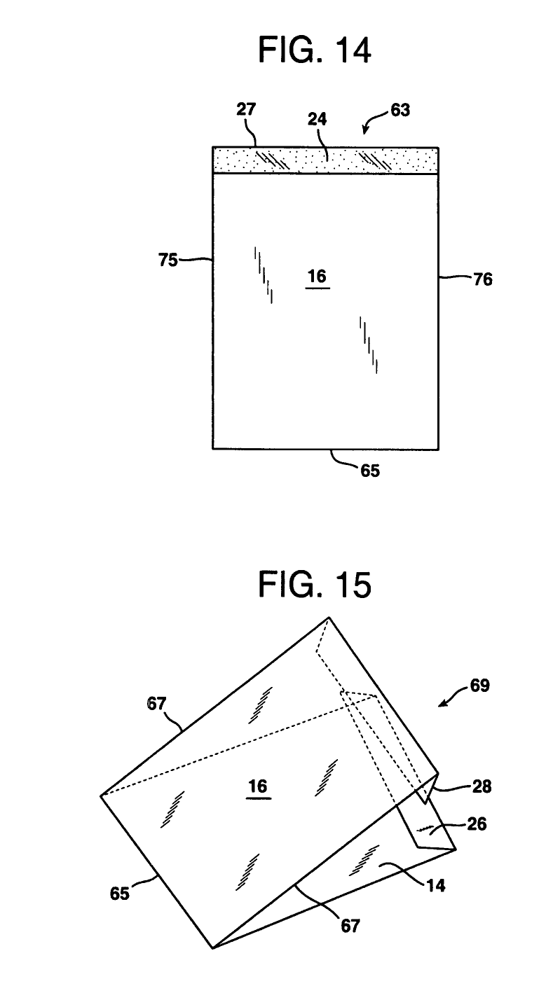

Regardless of the particular method used, the result (see FIG. 14) is a bag having an outer film surface of an easy open sealant 16, a bottom fold 65, a first side seal 75, a second side seal 76, and a sealed bag mouth 80 (see FIG. 13). FIG. 13 is a cross sectional view of a portion of a bag in accordance with the invention, wherein the bag mouth 80 is sealed with an easy open seal 71.

FIG. 15 is a simplified perspective view of a bag preform in accordance with one embodiment of the present invention (without the PSA being shown for the sake of clarity), before the first and second sides of the bag, and the bag mouth, have been sealed. Shown are an outer surface 16 of the first wall comprising an easy-open sealant; and an inner surface 14 of the second wall comprising a regular sealant; two side edges formed by transverse cuts 67 (see also FIG. 11), a bottom fold 65, bag mouth 69, and segments 26 and 28.

In an alternative embodiment to that shown in FIG. 12, FIG. 19 shows a cross sectional view of a portion of film or films, wherein a bag mouth is formed, in accordance with another embodiment of the invention. The essential difference between FIGS. 12 and 19, is that in FIG. 19 only one wall has been folded over at an end distal to the bottom portion. The resuit is folded edge portion 61, made up of two film segments, a folded portion formed between and connecting these two film segments, and a pressure sensitive adhesive adhering the first and second film segments. Thus, folded edge portion 61 corresponds to and can be formed in the same way as folded edge portion 61 of e.g. FIGS. 6, 7, and 12. However, the other wall disclosed in FIG. 19, including outer film surface 616 and inner film surface 614, does not include a folded edge portion, i.e. the “mouth” end of the wall has not been folded over at an end distal to the bottom portion. The two walls can nevertheless be brought together, similar to the arrangement shown in FIG. 13, such that an easy open bag is made that can function as described herein.

In the embodiment of FIG. 19, the inner surface 14 of the first wall, and the inner surface 614 of the second wall, each comprise a regular sealant. The outer surface 16 of the first wall comprises an easy-open sealant. The outer surface 616 of the second wall can comprise an easy-open sealant or a regular sealant. This can be achieved by using two different films, and bringing them together to form a bag. Each of the films will have an inner surface comprising a regular sealant. This insures that the side walls of the bag can be sealed together to form relatively strong seals. The bottom portion of the bag will in this particular embodiment not comprise a fold, but rather a seal such as a heat seal. The bag will thus be sealed on three sides. One of the films will be folded at the end thereof distal the bottom seal, to create the folded edge portion 61 of FIG. 19. The outer surface 16 of this film will thus be preselected to comprise an easy-open sealant, so that when the folded edge portion 61 is brought into contact with the inner surface 614 of the second film, and an easy-open seal is formed. The outer surface 616 of the second film can comprise either an easy-open or regular sealant. If an easy open sealant is used, a single film embodiment can be used as described in FIGS. 1 through 7. If a regular sealant is used, two distinct films can be used to form the bag.

Although application of the PSA may occur in-line with bag manufacture, it can also be done at a separate point in time and/or location. Thus, the operation illustrated in FIG. 1 can be completed, and the individual bags can be boxed or otherwise stored and shipped to a packager.

Alternatively, the operation illustrated in FIG. 1 can be completed, but the bag preforms not individually cut from the web, and the web with folded edges, and folded longitudinally on itself, can be rolled up and shipped to another part of the manufacturing facility, or to another location, for side sealing, cutting and production of bags.

In another embodiment, the operation illustrated in FIG. 1 can be completed, but the bag preforms not individually cut from the web, and the web with folded edges, and folded longitudinally on itself, can be rolled up and shipped to a packager where product can be put into each bag mouth and, before, during or after the filling operation, the individual bags can be separated from the web. Side seals can be installed either before shipping to the packager, or alternatively during the filling operation. In this latter alternative, the side sealing and cutting will be essentially a simultaneous or nearly simultaneous operation.

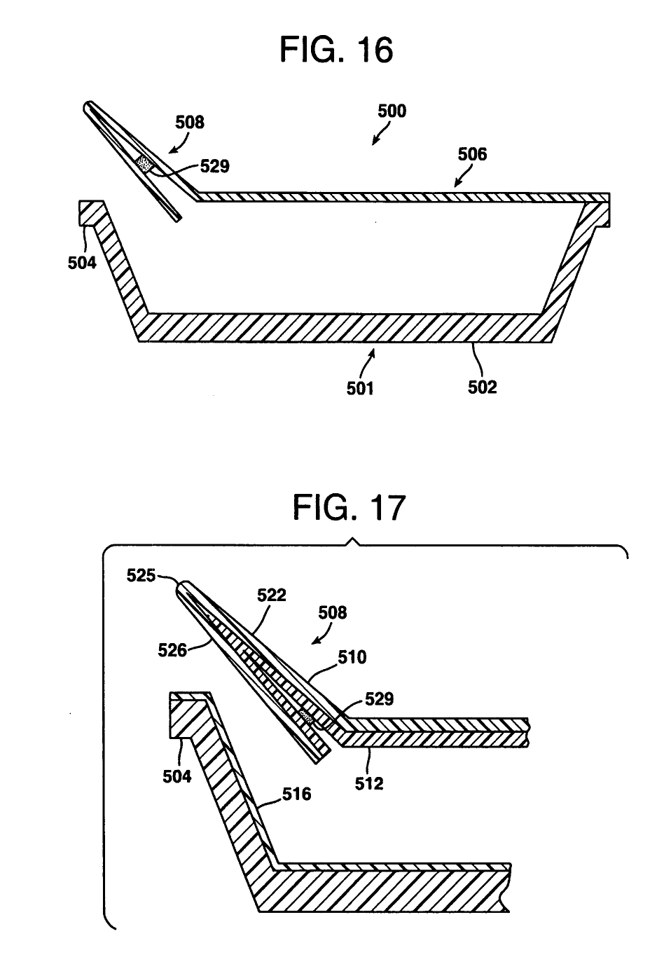

In another alternative embodiment, FIG. 16 is a cross sectional view of a package including a tray and lid in accordance with yet another embodiment of the present invention.

A tray 501, which can be made from any conventional material including foamed polystyrene, polycarbonate, polypropylene, PET, CPET, APET, PLA, nylon, or the like, includes a tray body 502 and a tray flange 504. A tray liner 516 (see FIG. 17) can be a discrete element, such as a layer or coating, that is adhered by any suitable means, such as adhesive, to the upper portion of the tray body as shown, and will include an inner surface bonded to the tray flange, and an outer surface comprising a regular sealant. Alternatively, the tray liner can be an integral part or portion of the tray body and flange, as long as its outer surface comprises a regular sealant. A lid 506 can be made from any suitable materials, including polymeric materials, and includes an outer surface 510 comprising an easy-open sealant, the outer surface being the surface of the lid furthest away from the tray interior; and an inner surface 512 comprising a regular sealant.

At one end of the lid, a folded edge portion 508 includes a first segment 522, a fold 525, and a second segment 526, and a pressure sensitive adhesive 529 disposed between and in contact with the first and second segments 522 and 526 of the folded edge portion 508.

FIG. 17 is an enlarged cross sectional view of a portion of the package of FIG. 16.

### Film Construction

FIG. 2 is a cross sectional view of a film 40 useful for making a package in accordance with one embodiment of the present invention. Film 40 has a first outer film surface 14, a second outer film surface 16, a first film side edge 18, and a second film side edge 20. Film 40 has a first outer layer 42 comprising a regular sealant, a second outer layer 46 comprising an easy-open sealant, and an intermediate layer 44 comprising an olefinic material such as ethylene/vinyl acetate copolymer (EVA).

The regular sealant of the first outer layer 42 can comprise in one embodiment a blend of 96%, by weight of the blend, of a single-site catalyzed ethylene/alpha olefin copolymer, having a 1-octene comonomer, and a density of 0.902 grams/cubic centimeter, available from Dow as AFFINITY™ PL 1850G; and 4%, by weight of the blend, of an antiblock/slip masterbatch made up of 88 wt % low density polyethylene (LDPE), 9.0 wt. % diatomaceous earth silica (SUPERFLOSS™), and 3.0 wt. % erucamide (KEMAMIDE™ E).

The easy-open sealant of the second outer layer 46 can comprise in one embodiment an easy-open sealant available from DuPont as APPEEL™ resin.

In one embodiment, film 40 has the following layer thickness, each by percent thickness of the total thickness of the film:

layer 42: 70%

layer 44: 10%

layer 46: 20%.

FIG. 3 is a cross sectional view of a film 50 useful for making a package in accordance with another embodiment of the present invention. Film 50 has a first outer film surface 14, a second outer film surface 16, a first film side edge 18, and a second film side edge 20. Film 50 has a first outer layer 52, corresponding to first outer layer 42, comprising a regular sealant; a second outer layer 56, corresponding to second outer layer 46, comprising an easy-open sealant, and an intermediate layer 54 comprising a polyamide or copolyamide, or a high density polyethylene. Tie layers 58 and 60 can comprises e.g. a maleic anhydride-modified ethylene/vinyl acetate copolymer (EVA) such as those available from DuPont under the BYNEL trademark.

In one embodiment, film 50 has the following layer thickness, each by percent thickness of the total thickness of the film:

layer 52: 40%

layer 58: 10%

layer 54: 25%

layer 60: 10%

layer 56: 15%

In another embodiment of the invention, a film useful for making a bag and package in accordance with the present invention can have only two layers, a first layer comprising or made up entirely of a regular sealant, and a second layer adhered to the first layer, and comprising or made up entirely of an easy-open sealant. FIGS. 5 to 10 illustrate such a film. The two layers can be adhered together by any suitable means, including conventional lamination techniques.

In still another embodiment, a film useful for making a bag and package in accordance with the present invention can have a first outer layer comprising a regular sealant, a second outer layer comprising an easy-open sealant, and a plurality of intermediate layers comprising materials such as ethylene polymer or copolymer, such as ethylene/alpha-olefin copolymer, polyamide, EVOH, PVDC, acrylonitrile, or other suitable polymers or copolymers. In some embodiments, tie layers can be used as appropriate to adhere adjacent layers.

Films useful for making a package in accordance with the present invention can be of any suitable thickness, such as from 0.5 and 20 mils, from 1 to 10 mils, or from 1.5 to 5 mils, such as 2 to 3 mils thick.

Films useful for making a package in accordance with the present invention can be made by any suitable process, including coextrusion, extrusion coating, extrusion lamination, and conventional lamination using polyurethane or other adhesives. These manufacturing processes are well known in the art. Extrusion can be done in annular or flat dies. The extrudate can be hot blown or solid-state oriented as desired. Chemical or electronic crosslinking of one or more layers of the webs can be done.

A bag or package in accordance with the invention will typically be hermetic when initially sealed.

It will be evident from a review of the present disclosure that the present invention provides a bag, process and package whereby a bag has an easy-open/reclosable seal at the bag mouth, that can be initially opened easily. Some of the contents of the bag can be removed, and the bag closed in a reclosable manner. This is accomplished in one embodiment by opening up each of the first folded edge portion and the second folded edge portion, thus exposing the PSA present in each, and thereafter adhering the two respective PSA coats together to close the bag. In an alternative embodiment disclosed herein, this is accomplished by opening up the single folded edge portion, thus exposing the PSA present therein, and thereafter adhering the PSA coat to the facing interior wall of the bag to close the bag.

In either embodiment, the bag can thereafter be easily reopened by peeling apart the bag mouth held together only by the PSA.

In some embodiments, a pull tab or the like can be installed, either integrally with the respectively wall of the bag or as a discrete member, on either or both of the first folded edge portion and the second folded edge portion. Such tab or tabs can facilitate the exposure of the PSA and reclosing of the bag.

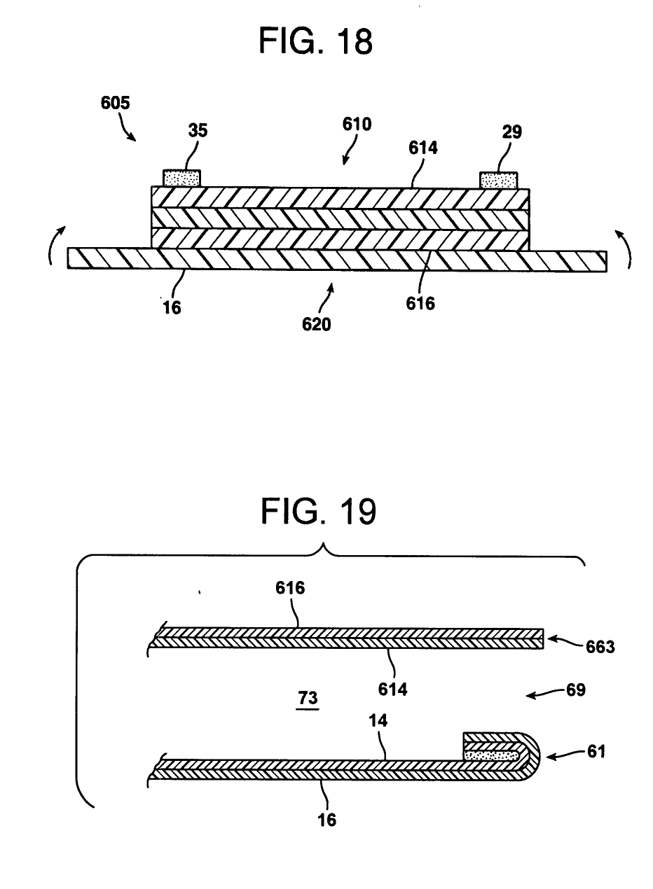

In an alternative embodiment to that disclosed in FIG. 1, and referring to FIG. 18, a film 605, like film 10, can be produced and processed as described in FIG. 1 and the remaining figures, but comprising a laminate of two different films. The first film 610, which can be e.g. a multilayer film such as a multilayer oxygen barrier film, can be like that depicted as shown in FIG. 2 or 3, except that it can include a first regular sealant surface 614 comprising a regular sealant making up at least a majority of the relevant film layer, and a second outer surface 616 also comprising a regular sealant making up at least a majority of the relevant film layer. Film 610 can be relatively thick, e.g. from 2 to 10 mils thick, e.g. 3 to 6 mils, or 4 to 5 mils thick. Laminated to film 610, for example by conventional lamination or extrusion coating, is a thin film 620, e.g. a monolayer or multilayer film, e.g. from 0.3 to 2 mils thick, such as 0.5 to 1.5 mils thick. This thin film 620 comprises an easy-open sealant making up at least a majority of the relevant film layer. Film 610 is narrower than the easy-open sealant film 620, such that when the first and second folded edge portions are produced, each folded edge portion is not twice the thickness of the original film, but only thicker than the original film by the thickness of the relatively thin film 620. This can offer the advantage of minimizing the thickness of the bag mouth portion of bags produced in accordance with the invention. This is an advantage where multiple bags so produced are stored in boxes or on rolls. The same is true in embodiments where the operation illustrated in FIG. 1 is completed, but the bags are not individually cut from the web, and the web with folded edges, and folded longitudinally on itself, is rolled up and shipped to a packager where product can be put into each bag mouth and, before, during or after the filling operation, the individual bags are separated from the web. Undesirable thickening of the edges of rolls of film or bags is minimized. In FIG. 18, PSA 29 and 35 is shown deposited on selected film segments of film 610. As disclosed herein, the PSA can be deposited additionally/instead on selected film segments of thin film 620. The relative thicknesses of films 610 and 620 as shown in FIG. 18 is not necessarily to scale.

Bags and packages in accordance with the invention can be used to package a variety of food or non food products, e.g. snack foods, luncheon meat, cheese, ready meals, infant care products, hardware, etc.

Films in accordance with the invention can be solid state oriented, and can be heat shrinkable.

The invention can be further understood with respect to the following three prophetic examples of an easy-open/reclosable package in accordance with the invention.

### Example 1

### Light Weight Package

For packaging relatively light items, or items with low density, such as cotton balls, certain plumbing components such as rubber washers and ‘O’ rings, grommets, and rubber bands. A typical minimum seal strength for the easy-open sealant for these kinds of light duty applications is about 25 gm/inch (in accordance with ASTM F88-05), and a typical minimum seal strength for the regular sealant for these kinds of light duty applications is about 100 gm/inch (ASTM F88-05). The minimum differential between the seal strength of the easy-open sealant, and the seal strength of the regular sealant will, for light packages, typically be 75 gm/inch. Generally, the seal strength of the easy-open sealant can range from e.g. 25 grams/inch to 500 grams/inch; the seal strength of the regular sealant can range from e.g. 100 grams/inch to 1500 grams/inch; and the difference between the seal strength of the easy-open sealant, and the seal strength of the regular sealant can be from 75 grams/inch to 1000 grams/inch.

### Example 2

### Medium Weight Package

For packaging moderately heavy items, or items with intermediate density, such as snack foods, dried fruits & nuts, dried sea weeds, noodles & pastas, luncheon meats, cheese etc. A typical minimum seal strength for the easy-open sealant for these kinds of medium duty applications is about 100 gm/inch (in accordance with ASTM F88-05), and a typical minimum seal strength for the regular sealant for these kinds of light duty applications is about 3 lbs/inch (ASTM F88-05). The minimum differential between the seal strength of the easy-open sealant, and the seal strength of the regular sealant will, for medium duty packages, typically be 2 lbs/inch. Generally, the seal strength of the easy-open sealant can range from e.g. 300 grams/inch to 2 lbs/inch; the seal strength of the regular sealant can range from e.g. 3 to 10 lb/inch; and the difference between the seal strength of the easy-open sealant, and the seal strength of the regular sealant can be from 2 lbs/inch to 8 lbs/inch.

### Example 3

### Heavy Weight Package

For packaging relatively heavy items, or items with high density, such as industrial hardware items, etc. A typical minimum seal strength for the easy-open sealant for these kinds of heavy duty applications is about 1 lb/inch (in accordance with ASTM F88-05), and a typical minimum seal strength for the regular sealant for these kinds of heavy duty applications is about 5 lbs/inch (ASTM F88-05). The minimum differential between the seal strength of the easy-open sealant, and the seal strength of the regular sealant will, for heavy duty packages, typically be 4 lbs/inch. Generally, the seal strength of the easy-open sealant can range from e.g. 1 lb/inch to 3 lbs/inch; the seal strength of the regular sealant can range from e.g. 5 to 30 lb/inch; and the difference between the seal strength of the easy-open sealant, and the seal strength of the regular sealant can be from 4 lbs/inch to 27 lbs/inch.

The film of the present invention can be made in one embodiment as a cast or blown film, and can be made in one embodiment into a solid state oriented film, having either monoaxial or biaxial orientation. The oriented film can in one embodiment be heat set.

In one embodiment, before the PSA is applied to a relevant film segment, the relevant film segment, or the entire film, is treated by e.g. corona treatment, flame or plasma treatment by processes well known to those of skill in the art.

It is to be understood that variations of the present invention can be made without departing from the scope of the invention, which is not limited to the specific embodiments and examples disclosed herein, but extends to the claims presented below.

What is claimed is:

1. An easy-open/reclosable bag comprising:
a) a first wall having an outer surface and an inner surface;
b) a second wall having an outer surface and an inner surface;
c) a bottom portion connecting the first and second walls;
d) a first side seal;
e) a second side seal; and
f) a bag mouth;
wherein the first wall comprises, at one end thereof distal from the bottom portion, a first folded edge portion comprising
i) a first segment,
ii) a fold,
iii) a second segment, and
iv) a pressure sensitive adhesive disposed between and in contact with the first and second segment of the first folded edge portion;
wherein the outer surface of the first wall comprises an easy-open sealant;
wherein the outer surface of the second wall comprises an easy-open sealant or a regular sealant; and
wherein the inner surface of the first wall, and the inner surface of the second wall, each comprises a regular sealant.

2. The easy-open/reclosable bag of claim 1 wherein the second wall comprises, at one end thereof distal from the bottom portion, a second folded edge portion comprising a first segment, a fold, a second segment, and a pressure sensitive adhesive disposed between and in contact with the first and second segment of the second folded edge portion;

3. The easy-open/reclosable bag of claim 1 wherein the bottom portion connecting the first and second walls comprises a fold.

4. The easy-open/reclosable bag of claim 1 wherein the bottom portion connecting the first and second walls comprises a seal.

5. The easy-open/reclosable bag of claim 1 wherein the first wall comprises a first layer comprising an easy-open sealant, a second layer comprising a regular sealant, and an intermediate layer, disposed between the first and third layers, comprising an ethylene polymer or copolymer.

6. The easy-open/reclosable bag of claim 1 wherein the pressure sensitive adhesive of the first and second folded edge portions has a thickness of from 1 to 25 micrometers.

7. The easy-open/reclosable bag of claim 1 wherein the regular sealant exhibits a seal strength at least 0.5 pounds per inch greater than the seal strength of the easy-open sealant.

8. The easy-open/reclosable bag of claim 1 wherein at least one of the first folded edge portion and the second folded edge portion comprises a pull tab.

9. A method of making an easy-open/reclosable bag comprising:
a) providing a film comprising
i) a first surface comprising a regular sealant,
ii) a second surface comprising an easy-open sealant,
iii) a first side edge, and
iv) a second side edge;
b) coating a first selected film segment of the first surface adjacent the first side edge with a pressure sensitive adhesive;
c) coating a second selected film segment of the first surface adjacent the second side edge with a pressure sensitive adhesive;
d) folding the first side edge over the coated first selected film segment of the first surface to form a first folded edge portion;
e) folding the second side edge over the coated second selected film segment of the first surface to form a second folded edge portion;
f) folding the film on itself along a longitudinal fold line;
g) transversely cutting the longitudinally folded film at selected intervals to form a plurality of discrete bag preforms each having a first side preform edge and a second side preform edge; and
h) sealing each of the first side preform edges and the second side preform edges to form a plurality of easy-open/reclosable bags each comprising
i) a bottom portion,
ii) a first side seal,
iii) a second side seal, and
iv) a bag mouth.

10. The method of claim 9 wherein the film comprises a thermoplastic material.

11. The method of claim 9 wherein the easy-open sealant exhibits a seal strength of from 0.5 to 3.0 pounds per inch (ASTM F904-98).

12. The method of claim 9 wherein the regular sealant exhibits a seal strength of from 3.0 to 8.0 pounds per inch (ASTM F904-98).

13. The method of claim 9 wherein the film comprises a first layer comprising an easy-open sealant, a second layer comprising a regular sealant, and an intermediate layer, disposed between the first and third layers, comprising an ethylene polymer or copolymer.

14. The method of claim 9 wherein the pressure sensitive adhesive of the first and second folded edge portions has a thickness of from 1.0 to 8.0 micrometers.

15. The method of claim 9 wherein the regular sealant exhibits a peel strength at least one pound per inch greater than the peel strength of the easy-open sealant.

16. The method of claim 9 wherein at least one of the first folded edge portion and the second folded edge portion comprises a pull tab.

17. An easy-open/reclosable package comprising:
a) a tray comprising;
i) a tray body,
ii) a tray flange, and
iii) a tray liner, the tray liner having an outer surface comprising a regular sealant;
b) a lid comprising
i) an outer surface comprising an easy-open sealant,
ii) an inner surface comprises a regular sealant, and
iii) at one end of the lid, a folded edge portion comprising
(a) a first segment,
(b) a fold,
(c) a second segment, and
(d) a pressure sensitive adhesive disposed between and in contact with the first and second segment of the folded edge portion; and
c) a product in the package;
wherein the lid is sealed to at least a portion of the outer surface of the tray liner.

18. The package of claim 17 wherein the tray comprises a material selected from polystyrene, polypropylene, polyethylene terephthalate, or polycarbonate, and the lid comprises a thermoplastic material.

19. The package of claim 17 wherein the easy-open sealant exhibits a peel strength of from 0.5 to 3.0 pounds per inch (ASTM F904-98).

20. The package of claim 17 wherein the product comprises a food product.

21. The method of claim 9 wherein, prior to steps b) and c), the first selected film segment and second selected film segment are corona treated.
